(19) United States
(12) Patent Application Publication
(10) Pub. No.: US 2019/0021243 A1
(43) Pub. Date: Jan. 24, 2019

(54) POWER BLOWER

(71) Applicant: MAKITA CORPORATION, Anjo-shi (JP)

(72) Inventors: Shinsuke NAKA, Anjo-shi (JP); Ryoji ZAMA, Anjo-shi (JP)

(73) Assignee: MAKITA CORPORATION, Anjo-shi, Aichi (JP)

(21) Appl. No.: 16/014,598

(22) Filed: Jun. 21, 2018

(30) Foreign Application Priority Data
Jul. 21, 2017 (JP) 2017-142102

(51) Int. Cl. A01G 20/47

(52) U.S. Cl. CPC A01G 20/47; F04D 25/08

(57) ABSTRACT

A power blower includes a power blower main body and a blower tube member. The main body takes in air through an air intake portion by rotation of a blower fan rotated by a motor and discharges the air from an air discharge portion. The blower tube member has an opening on a base end side through which air discharged from the air discharge portion of the main body flows in, and an opening on a tip end side from which the air which has flowed in, is blown out. When a plane perpendicular to an axis of the blower tube member is in contact with the opening at the tip end side of the blower tube member, blown-air passages are formed on opposite sides of contact portions of the opening at the tip end side of the blower tube member and the plane.

### CROSS-REFERENCE TO RELATED APPLICATION

The application claims priority from Japanese Patent Application No. 2017-142102 filed on Jul. 21, 2017, the entire contents of which are incorporated herein by reference.

### BACKGROUND OF THE INVENTION

### Field of the Invention

The present invention relates to a power blower.

### Description of Related Art

Power blowers disclosed in JP 2008-106660 A and JP 2005-163765 A are for use in blowing fallen leaves, grass clippings, dust, or the like, to sweep them up. In the power blowers disclosed in JP 2008-106660 A and JP 2005-163765 A, an engine rotates a blower fan to draw in air and blow out air from an opening provided at the tip end side of a blower tube.

There may be problems when an opening at the tip end side of the blower tube disclosed in JP 2008-106660 A and JP 2005-163765 A comes into contact with a flat surface such as the ground, which might cause the opening at the tip end side of the blower tube to be obstructed by the flat surface. This closure significantly reduces an air amount (blown air amount) expelled from the opening at the tip end side of the blower tube, so that a load applied on the blower fan significantly decreases, and thus, the number of revolutions of the engine might excessively increase.

The present invention has been made in view of such circumstances, and an object of the present invention is to prevent, in a power blower, an opening at a tip end side of a blower tube from being obstructed.

### SUMMARY OF THE INVENTION

According to an aspect of the present invention, a power blower is provided. The power blower comprises: a power blower main body having a blower fan rotated by a motor, an air intake portion, and an air discharge portion, the power blower main body taking in air through the air intake portion by rotation of the blower fan and discharging the air from the air discharge portion; and a blower tube member having an opening at the base end side through which air discharged from the air discharge portion of the power blower main body flows in, and an opening at the tip end side from which the air which has flowed in, is blown out. In the power blower, when a plane that is perpendicular to an axis of the blower tube member is in contact with the opening at the tip end side of the blower tube member, blown-air passages defined by the opening at the tip end side of the blower tube member and the plane are formed on opposite sides of contact portions of the opening at the tip end side of the blower tube member and the plane, and air which has flowed through the blower tube member passes through the blown-air passages at the opposite sides so that the air is blown out to the outside of the blower tube member.

Other objects and features of aspects of the present invention will be understood from the following description with reference to the accompanying drawings.

### BRIEF DESCRIPTION OF THE DRAWINGS

FIG. 1 is a perspective view of a power blower according to a first embodiment of the present invention.

FIG. 2 is a left side view of the power blower illustrated in FIG. 1.

FIG. 3 is a cross-sectional view of the power blower illustrated in FIG. 1 that is cut into right and left portions and viewed from the left.

FIG. 4A is a top plan view of a tip end portion of a blower tube member according to the first embodiment.

FIG. 4B is a left side view of the tip end portion of the blower tube member according to the first embodiment.

FIG. 4C is a right side view of the tip end portion of the blower tube member according to the first embodiment.

FIG. 4D is a view illustrating an opening at the tip end side of the blower tube member when viewed from arrow A of FIG. 4A.

FIG. 5A is a view of blown-air passages according to the first embodiment when viewed from above.

FIG. 5B is a view of a blown-air passage according to the first embodiment when viewed from the left.

FIG. 5C is a view of a blown-air passage according to the first embodiment when viewed from the right.

FIG. 6A is a view illustrating an opening area of the left blown-air passage according to the first embodiment.

FIG. 6B is a view illustrating an opening area of the right blown-air passage according to the first embodiment.

FIG. 7 is a top plan view of a power blower according to a second embodiment of the present invention.

FIG. 8A is a top plan view of a blower tube member according to the second embodiment.

FIG. 8B is a right side view of the blower tube member according to the second embodiment.

FIG. 8C is a view illustrating an opening at the tip end side of the blower tube member when viewed from arrow B of FIG. 8A.

FIG. 9A is a view of blown-air passages according to the second embodiment when viewed from above.

FIG. 9B is a view of a blown-air passage according to the second embodiment when viewed from the right.

FIG. 10 is a view illustrating an opening area of the right blown-air passage according to the second embodiment.

FIG. 11A is a top plan view of a tip end portion of a blower tube member according to a third embodiment of the present invention.

FIG. 11B is a left side view of the tip end portion of the blower tube member according to the third embodiment.

FIG. 11C is a right side view of the tip end portion of the blower tube member according to the third embodiment.

FIG. 11D is a view illustrating an opening at the tip end side of the blower tube member when viewed from arrow C of FIG. 11A.

FIG. 12A is a view of blown-air passages according to the third embodiment when viewed from above.

FIG. 12B is a view of a blown-air passage according to the third embodiment when viewed from the left.

FIG. 12C is a view of a blown-air passage according to the third embodiment when viewed from the right.

FIG. 13A is a view illustrating an opening area of the left blown-air passage according to the third embodiment.

FIG. 13B is a view illustrating an opening area of the right blown-air passage according to the third embodiment.

### DESCRIPTION OF PREFERRED EMBODIMENTS

Hereinbelow, embodiments of the present invention will be described with reference to the accompanying drawings.

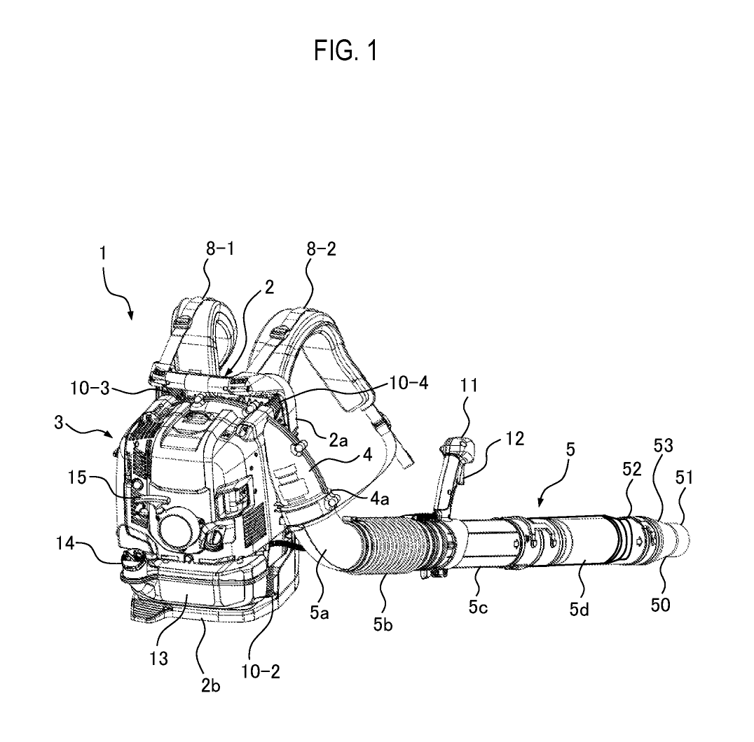

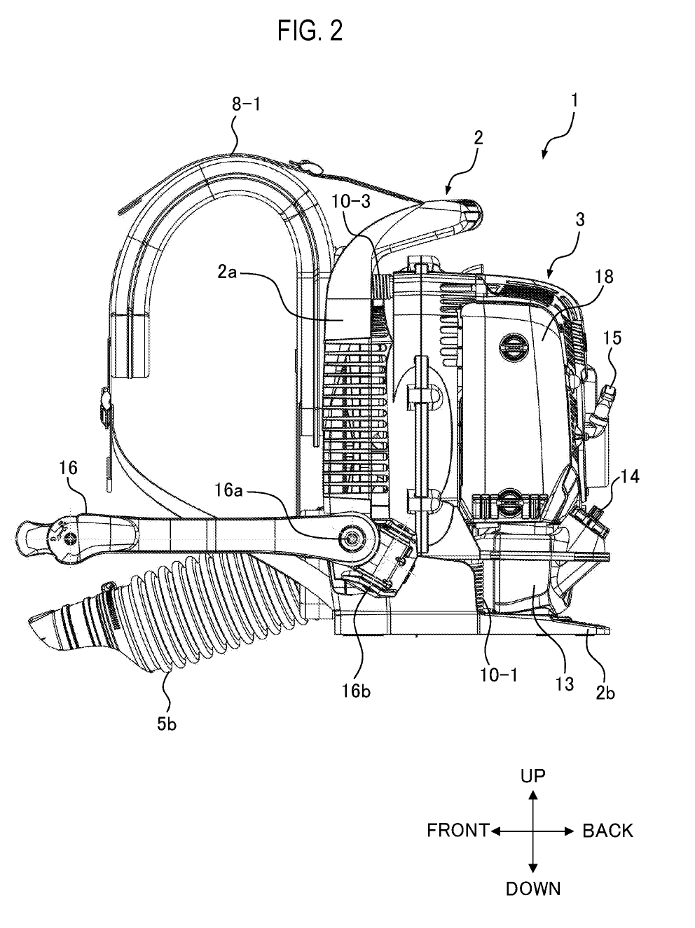

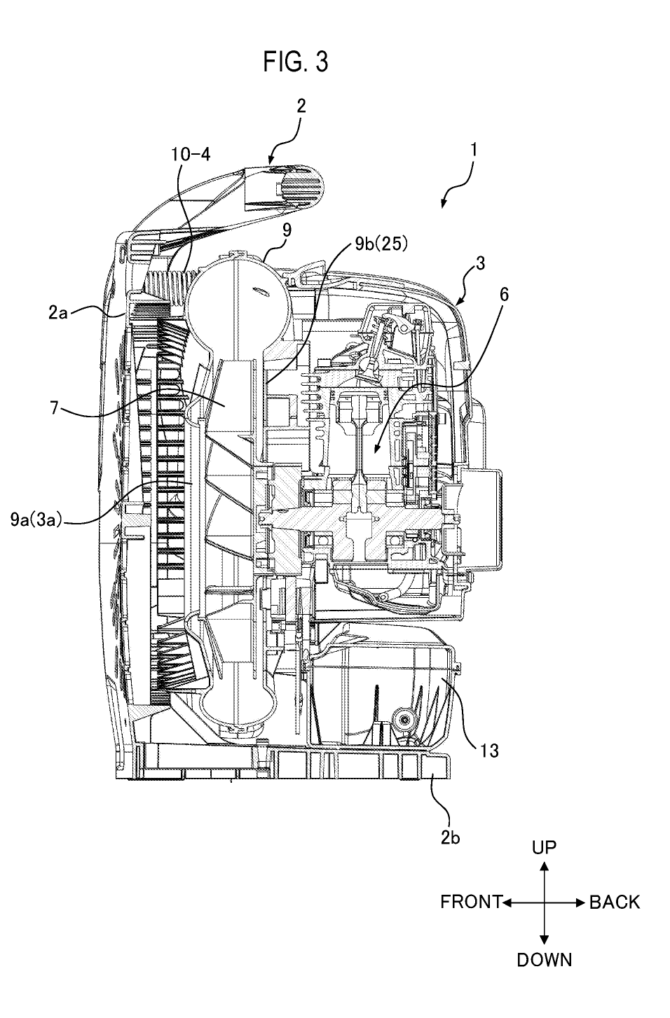

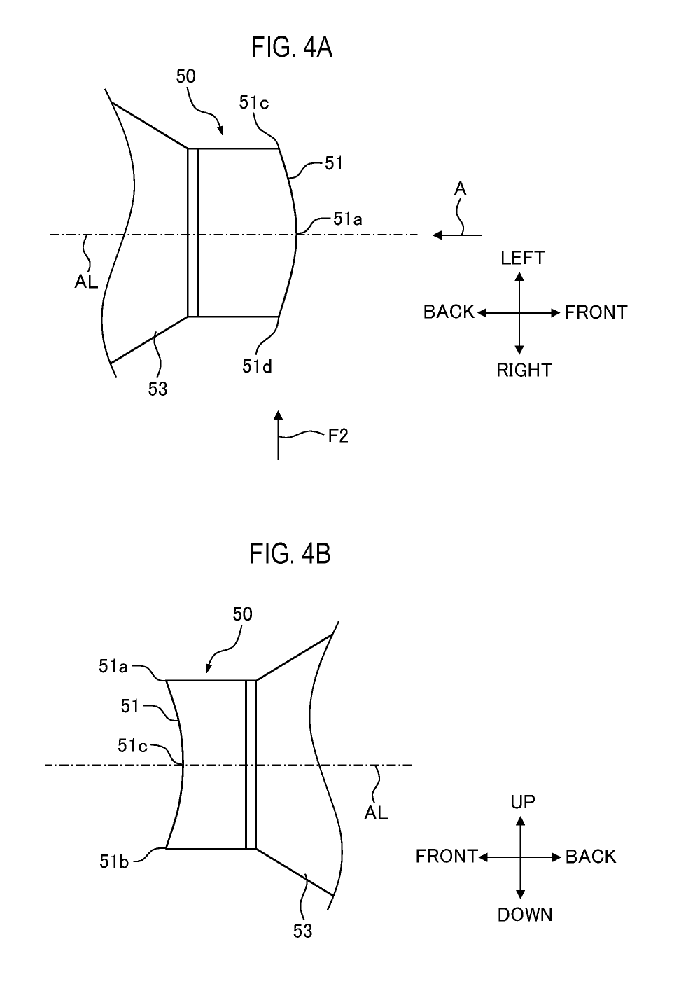

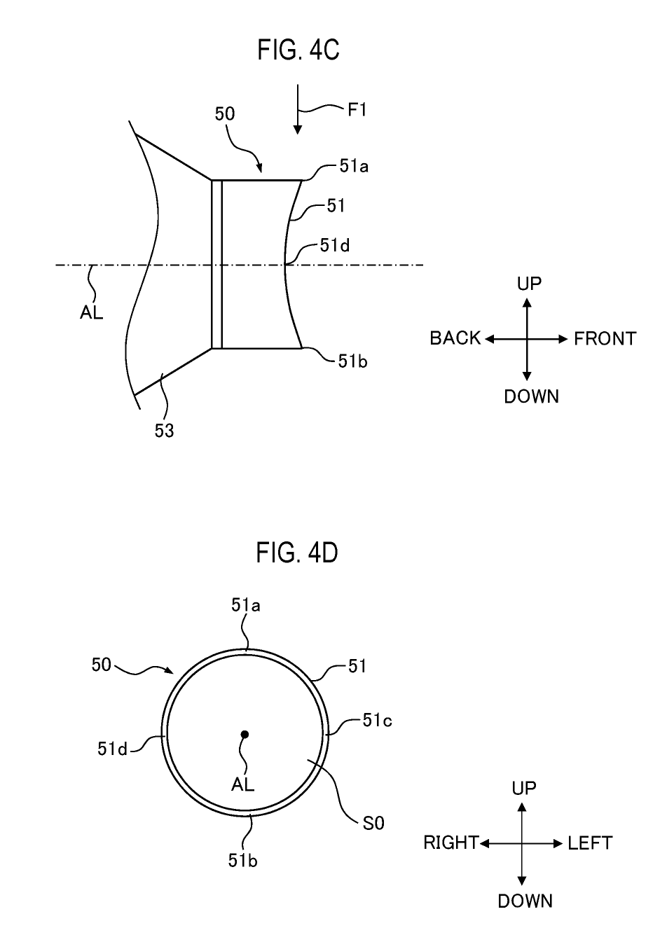

FIGS. 1 to 3 illustrate a power blower 1 according to a first embodiment of the present invention. FIGS. 4A to 4D illustrate a tip end portion of a blower tube member 50 according to the present embodiment. The power blower 1 will be described with the up and down, and the front and back thereof, defined as indicated in FIGS. 2 and 3, for the purpose of illustration. In addition, the blower tube member 50 will be described with the up and down, the front and back, and the right and left thereof defined as indicated in FIGS. 4A to 4D. Although the present embodiment will be described by employing an engine (internal combustion engine) 6 as an example of a motor, the motor is not limited to the engine 6.

The power blower 1 illustrated in FIGS. 1 to 3 is a backpack-type engine blower. In the power blower 1, a power blower main body (blower unit) 3 is mounted on a frame 2 that enables an operator to carry on the back, and a blower tube 5 that allows air to be discharged communicates with an air discharge portion (discharge duct) 4 of the power blower main body 3. The power blower main body 3 is configured to take in air through an air intake portion 3a (intake port 9a of a volute case 9) by rotation of a blower fan (impeller) 7 driven by the engine 6 and to discharge the air from the air discharge portion 4. That is, the power blower main body 3 has the blower fan 7 rotated by the engine 6, the air intake portion 3a, and the air discharge portion 4. The base end of the blower tube 5 is supported by the frame 2 and assembled to an opening end portion of the air discharge portion 4 to provide communication.

The frame 2 enables an operator to carry the power blower main body 3 on the back. The frame 2 has an L-shape including a back contacting portion 2a extending perpendicularly and contacting the back of an operator, and a base portion 2b extending rearward from a lower portion of the back contacting portion 2a. To the back contacting portion 2a of the frame 2, a pair of shoulder straps 8-1, 8-2 that allows an operator to carry on the back, is attached.

The blower fan 7 is accommodated in the volute case 9. To the volute case 9, the engine 6 that rotates the blower fan 7 is integrally assembled.

The power blower main body 3 is mounted on the frame 2 via a vibration reducing mechanism. Coil springs 10-1, 10-2 that constitute the vibration reducing mechanism are disposed between a lower portion of the power blower main body 3 and the base portion 2b of the frame 2. Coil springs 10-3, 10-4 that constitute the vibration reducing mechanism are disposed between a front portion of the power blower main body 3 and the back contacting portion 2a of the frame 2.

In a front portion of the volute case 9, the intake port 9a for air is provided. On the right side of the volute case 9, the tubular air discharge portion 4 is integrally provided. At the tip end of the tubular air discharge portion 4, an enlarged diameter portion 4a having a larger diameter is provided. To the enlarged diameter portion 4a of the air discharge portion 4, the base end of the blower tube 5 supported by the frame 2 is assembled by insertion.

The blower tube 5 includes an elbow 5a communicating with the air discharge portion 4 of the power blower main body 3, a flexible bellows pipe 5b joined to the tip end of the elbow 5a, a rotating pipe 5c joined to the tip end of the bellows pipe 5b, a short pipe 5d joined to the rotating pipe 5c, and the blower tube member (end nozzle) 50 joined to the short pipe 5d.

Near the joining portion of the rotating pipe 5c and the bellows pipe 5b, a control handle 11 for holding the blower tube 5 is attached. The control handle 11 is provided with a trigger lever 12 for manipulating the power blower main body 3.

On the base portion 2b arranged on the lower portion of the power blower main body 3, a fuel tank 13 for storing liquid fuel such as gasoline is mounted. On an upper portion of the fuel tank 13, a fuel tank cap 14 is provided. The power blower main body 3 is provided with a starter handle 15 for starting up the engine 6. The fuel in the fuel tank 13 is fed to a carburetor (not illustrated) via a fuel pipe (not illustrated), the vaporized fuel is sent to the engine 6 together with air, and the mixture is spark-ignited by a spark plug (not illustrated). The exhaust generated after combustion is introduced into a muffler (not illustrated) to reduce the amount of noise thereof, and then, released to the outside.

A arm-type throttle lever 16 illustrated in FIG. 2 is configured such that the arm thereof is rotatable upward and downward around a rotating axis 16a and the arm is freely moved outward around a rotating shaft 16b. The rotating shaft 16b is provided with a spring that biases the arm in a direction making the arm which has moved outward return inward. This can make it possible to adjust the throttle in suitable positions depending on posture during operation.

Hereinbelow, main procedures of use of the power blower 1 will be described. First, the starter handle 15 is pulled by an operator to start up the engine 6, and then, the frame 2 is carried on the back, the control handle 11 is grasped with the right hand, and the throttle is manipulated by the arm-type throttle lever 16 with the left hand, to make air blown out from the opening 51 at the tip end side of the blower tube member 50 of the blower tube 5.

In the present embodiment, in a rear portion of the volute case 9, an air supply port 9b is formed. The air supply port 9b serves as a guide 25 that guides a part of air taken in through the intake port 9a by rotation of the blower fan 7 (i.e., a smaller part of air taken in through the intake port 9a by rotation of the blower fan 7) toward the engine 6 as cooling air. The remainder of air taken in through the intake port 9a by rotation of the blower fan 7 (i.e., a major part of air taken in through the intake port 9a by rotation of the blower fan 7) is blown out from the opening 51 at the tip end side of the blower tube member 50 of the blower tube 5, as described above. Thus, the blower fan 7 functions as a “cooling-air supplying device”, and sends cooling air to the engine 6. The cooling air from the blower fan 7 passes through the guide 25 and hits the engine 6. In the present embodiment, the guide 25 that guides a part of air taken in through the intake port 9a by rotation of the blower fan 7 toward the engine 6 is provided in the volute case 9. In addition thereto, or as an alternative thereto, the guide 25 may be provided in the air discharge portion 4.

The blower tube member 50 illustrated in FIGS. 1 and 4A to 4D is a tubular member having a circular cross-section. An axis AL corresponding to the central axis of the blower tube member 50 is linear. For example, the blower tube member 50 may be made of resin. The blower tube member 50 includes an opening 51 at the tip end side, an opening 52 at the base end side, and a tapered portion 53 formed between the openings 51, 52. The tapered portion 53 has a shape in which diameters decrease toward the tip end (opening 51) of the blower tube member 50. Thus, a cross-sectional area (opening area) S0 of the opening 51 at the tip end side is less than that of the opening 52 at the base end side.

In the present embodiment, as illustrated in FIG. 4A, when the blower tube member 50 is viewed in a first direction F1 that is perpendicular to the axis AL of the blower tube member 50 (e.g., in a direction from up to down, as illustrated in FIG. 4C), the opening 51 at the tip end side of the blower tube member 50 has an outline that is smoothly convex in a manner such that the outline approaches the base end (opening 52) of the blower tube member 50 farther from the axis AL of the blower tube member 50. In other words, as illustrated in FIG. 4A, when the blower tube member 50 is viewed in the first direction F1 that is perpendicular to the axis AL of the blower tube member 50, the opening 51 at the tip end side of the blower tube member 50 has an outline that is smoothly convex to the front (convex shape). Each of an upper end 51a and a lower end 51b of the opening 51 at the tip end side of the blower tube member 50 is the vertex of the convex shape. Furthermore, as illustrated in FIG. 4A, when the blower tube member 50 is viewed in the first direction F1 that is perpendicular to the axis AL of the blower tube member 50, the opening 51 at the tip end side of the blower tube member 50 has an outline having line symmetry with respect to the axis AL of the blower tube member 50.

On the other hand, in the present embodiment, as illustrated in FIG. 4C, when viewed in a second direction F2 that is perpendicular to the axis AL of the blower tube member 50 and is perpendicular to the first direction F1 (e.g., in a direction from the right to the left, as illustrated in FIG. 4A), the opening 51 at the tip end side of the blower tube member 50 has an outline that is concave in a manner such that the outline departs from the base end (opening 52) of the blower tube member 50 farther from the axis AL of the blower tube member 50. In other words, as illustrated in FIG. 4C, when viewed in the second direction F2 that is perpendicular to the axis AL of the blower tube member 50 and is perpendicular to the first direction F1, the opening 51 at the tip end side of the blower tube member 50 has an outline that is smoothly concave to the back (concave shape). Each of a left end 51c and a right end 51d of the opening 51 at the tip end side of the blower tube member 50 is the bottom of the concave shape. Furthermore, as illustrated in FIG. 4C, when the blower tube member 50 is viewed in the second direction F2 that is perpendicular to the axis AL of the blower tube member 50 and is perpendicular to the first direction F1, the opening 51 at the tip end side of the blower tube member 50 has an outline having line symmetry with respect to the axis AL of the blower tube member 50.

Thus, in the opening 51 at the tip end side of the blower tube member 50 according to the present embodiment, the left end 51c and the right end 51d are located behind the upper end 51a and the lower end 51b. In other words, in the opening 51 at the tip end side of the blower tube member 50 according to the present embodiment, the left end 51c and the right end 51d are located at the base end side (opening 52 side) of the blower tube member 50 with respect to the upper end 51a and the lower end 51b.

For example, the blower tube member 50 having the opening 51 at the tip end side with the outline described above, may be formed by injection molding. Alternatively, a blower tube member 50 having an opening 51 at the tip end side with a flat outline may be prepared and the blower tube member 50 may be subjected to cutting so that the outline of the opening 51 at the tip end side has the convex and concave shapes described above.

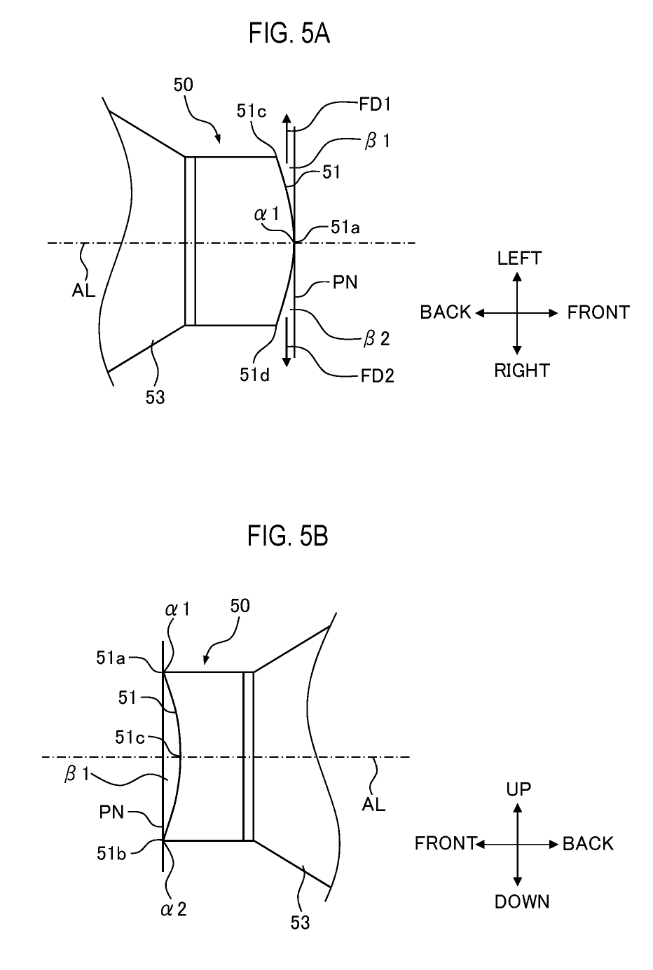

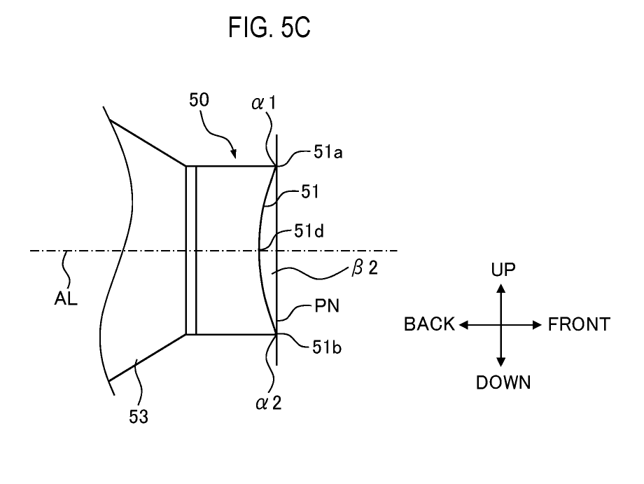

FIGS. 5A to 5C are views illustrating blown-air passages (31, (32, according to the present embodiment. FIGS. 5A to 5C illustrate a state in which a plane PN that is perpendicular to the axis AL of the blower tube member 50 is in contact with the opening 51 at the tip end side of the blower tube member 50. Herein, the plane PN may be a flat surface of any object. For example, the plane PN may be a flat ground (ground surface).

When the plane PN is in contact with the opening 51 at the tip end side of the blower tube member 50, the blown-air passages (31, (32 defined by the opening 51 at the tip end side of the blower tube member 50 and the plane PN are formed on both right and left sides of contact portions α1, α2 of the opening 51 at the tip end side of the blower tube member 50 and the plane PN. Herein, the contact portion a1 is a portion in which the upper end 51a of the opening 51 at the tip end side of the blower tube member 50 is in contact with the plane PN. The contact portion a2 is a portion in which the lower end 51b of the opening 51 at the tip end side of the blower tube member 50 is in contact with the plane PN. In a state in which the plane PN is in contact with the opening 51 at the tip end side of the blower tube member 50, air which has flowed in the blower tube member 50 through the opening 52 at the base end side and has flowed through the blower tube member 50, can be blown out to the outside (outside the blower tube member 50) through the right and left blown-air passages β1, β2.

Most air to be blown out from the left blown-air passage β1 is blown out leftward along a flow direction FD1. On the other hand, most air to be blown out from the right blown-air passage β2 is blown out rightward along a flow direction FD2. Thus, the flow direction FD1 of air blown out from the left blown-air passage β1 and the flow direction FD2 of air blown out from the right blown-air passage β2 are opposite to each other.

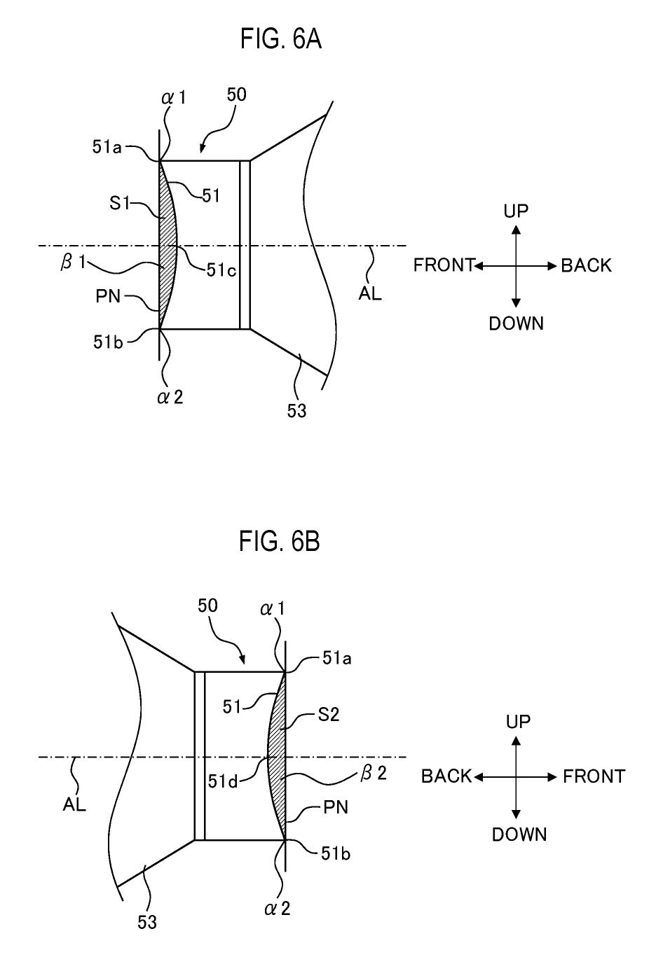

FIG. 6A is a view illustrating an opening area S1 of the left blown-air passage β1 according to the present embodiment. FIG. 6B is a view illustrating an opening area S2 of the right blown-air passage β2 according to the present embodiment.

In the present embodiment, the opening area S1 of the left blown-air passage β1 when viewed in the flow direction FD1 of air blown out from the left blown-air passage β1, and the opening area S2 of the right blown-air passage β2 when viewed in the flow direction FD2 of air blown out from the right blown-air passage β2 are the same. Thus, in the present embodiment, when the plane PN is in contact with the opening 51 at the tip end side of the blower tube member 50, air which has flowed through the blower tube member 50 can be equally blown out rightward and leftward from the opening 51 at the tip end side of the blower tube member 50. Herein, the flow directions FD1, FD2 are perpendicular to a line connecting the contact portions α1, α2 and are perpendicular to the axis AL of the blower tube member 50.

In the present embodiment, when the opening 51 at the tip end side of the blower tube member 50 is viewed from the left of the blower tube member 50, an area surrounded by the outline of the opening 51 at the tip end side of the blower tube member 50 and the plane PN corresponds to the opening area S1 of the left blown-air passage β1 (see FIG. 6A). Furthermore, when the opening 51 at the tip end side of the blower tube member 50 is viewed from the right of the blower tube member 50, an area surrounded by the outline of the opening 51 at the tip end side of the blower tube member 50 and the plane PN corresponds to the opening area S2 of the right blown-air passage β2 (see FIG. 6B).

Assuming that an opening area of the opening 51 at the tip end side of the blower tube member 50 (i.e., an area surrounded by the inner periphery of the opening 51 at the tip end side of the blower tube member 50 as illustrated in FIG. 4D) is S0, it is preferable that the sum of the opening area S1 of the left blown-air passage β1 and the opening area S2 of the right blown-air passage β2 be greater than or equal to 10% of the opening area S0. That is, it is preferable that the opening areas S0, S1, S2 satisfy the following equation (1):

(S1+S2)/S0≥0.1 (1)

According to the present embodiment, the power blower 1 includes: the power blower main body 3 having the blower fan 7 rotated by the engine 6, which is an example of a motor, the air intake portion 3a, and the air discharge portion 4, the power blower main body 3 taking in air through the air intake portion 3a by rotation of the blower fan 7 and discharging the air from the air discharge portion 4; and the blower tube member 50 having the opening 52 at the base end side through which air discharged from the air discharge portion 4 of the power blower main body 3 flows in, and the opening 51 at the tip end side from which air which has flowed in, is blown out. When the plane PN that is perpendicular to the axis AL of the blower tube member 50 is in contact with the opening 51 at the tip end side of the blower tube member 50, the blown-air passages β1, β2 defined by the opening 51 at the tip end side of the blower tube member 50 and the plane PN are formed on opposite sides of the contact portions α1, α2 of the opening 51 at the tip end side of the blower tube member 50 and the plane PN, and air which has flowed through the blower tube member 50 passes through the blown-air passages β1, β2 at the opposite sides so that the air is blown out to the outside of the blower tube member 50. Thus, even when the opening 51 at the tip end side of the blower tube member 50 is brought into contact with the plane PN such as the ground, since the blown-air passages β1, β2 are formed, it is possible to prevent the opening 51 at the tip end side of the blower tube member 50 from being obstructed.

Furthermore, according to the present embodiment, when viewed in the flow directions FD1, FD2 of air blown out from the blown-air passages β1, β2 at the opposite sides, the opening area S1 of the blown-air passage β1 on one side (left) and the opening area S2 of the blown-air passage β2 on the other side (right) are the same. Thus, even in a state in which the opening 51 at the tip end side of the blower tube member 50 is brought into contact with the plane PN such as the ground, air which has flowed through the blower tube member 50 can be evenly blown out rightward and leftward from the opening 51 at the tip end side of the blower tube member 50 through the blown-air passages β1, β2 in a well-balanced state. Herein, “one side” corresponds to a first side, and “the other side” corresponds to a second side opposite to the first side.

Furthermore, according to the present embodiment, when viewed in the flow directions FD1, FD2 of air blown out from the blown-air passages β1, β2 at the opposite sides, the sum of the opening area S1 of the blown-air passage β1 on one side (left) and the opening area S2 of the blown-air passage β2 on the other side (right) (i.e., S1+S2) is greater than or equal to 10% of the opening area S0 of the opening 51 at the tip end side of the blower tube member 50. Thus, even in a state in which the opening 51 at the tip end side of the blower tube member 50 is brought into contact with the plane PN such as the ground, it is possible to secure a sufficient blown-air amount to the extent it can prevent over-rotation of the engine 6.

Furthermore, according to the present embodiment, the flow direction FD1 of air blown out from the blown-air passage β1 on one side (left) and the flow direction FD2 of air blown out from the blown-air passage β2 on the other side (right) are opposite to each other. Thus, even in a state in which the opening 51 at the tip end side of the blower tube member 50 is brought into contact with the plane PN such as the ground, a reaction force of the pressure (discharge pressure) of air blown out from the left blown-air passage β1 and that of the pressure (discharge pressure) of air blown out from the right blown-air passage β2 are cancelled by each other, and thus, it is possible to prevent the blower tube member 50 from flapping.

Furthermore, according to the present embodiment, when viewed in a direction that is perpendicular to the axis AL of the blower tube member 50 (i.e., in the first direction F1, see FIG. 4C), the opening 51 at the tip end side of the blower tube member 50 has the outline that is convex in a manner such that the outline approaches the base end (opening 52) of the blower tube member 50 farther from the axis AL of the blower tube member 50 (see FIG. 4A). Thus, by bringing the opening 51 at the tip end side of the blower tube member 50 into contact with the plane PN at the vertexes of the convex shapes, the blown-air passages β1, β2 can be formed on the opposite sides of the contact portions α1, α2.

Furthermore, according to the present embodiment, when viewed in a direction that is perpendicular to the axis AL of the blower tube member 50 (i.e., in the second direction F2, see FIG. 4A), the opening 51 at the tip end side of the blower tube member 50 has the outline that is concave in a manner such that the outline departs from the base end (opening 52) of the blower tube member 50 farther from the axis AL of the blower tube member 50 (see FIG. 4C). An area surrounded by this concave shape and the plane PN can correspond to the opening areas S1, S2 of the blown-air passages β1, β2.

Furthermore, according to the present embodiment, when viewed in the first direction F1 that is perpendicular to the axis AL of the blower tube member 50 (see FIG. 4C), the opening 51 at the tip end side of the blower tube member 50 has the outline that is convex in a manner such that the outline approaches the base end (opening 52) of the blower tube member 50 farther from the axis AL of the blower tube member 50 (see FIG. 4A), and when viewed in the second direction F2 that is perpendicular to the axis AL of the blower tube member 50 and is perpendicular to the first direction F1 (see FIG. 4A), the opening 51 at the tip end side of the blower tube member 50 has the outline that is concave in a manner such that the outline departs from the base end (opening 52) of the blower tube member 50 farther from the axis AL of the blower tube member 50 (see FIG. 4C). Thus, by bringing the opening 51 at the tip end side of the blower tube member 50 into contact with the plane PN at the vertexes of the convex shapes, the blown-air passages β1, β2 having the opening areas S1, S2 can be formed on the opposite sides of the contact portions α1, α2.

Furthermore, according to the present embodiment, the axis AL of the blower tube member 50 extends linearly. This makes it possible to blow out air flowing in a highly straight manner from the opening 51 at the tip end side of the blower tube member 50.

Furthermore, according to the present embodiment, the power blower main body 3 has the guide 25 (e.g., air supply port 9b) that guides a part of air taken in through the air intake portion 3a (intake port 9a) by rotation of the blower fan 7, toward the motor (engine 6). Thus, a part of air guided by the guide 25 can function as cooling air for cooling the engine 6. In the present embodiment, even when the opening 51 at the tip end side of the blower tube member 50 is brought into contact with a plane PN such as the ground, since the blown-air passages β1, β2 are formed, it is possible to prevent the opening 51 at the tip end side of the blower tube member 50 from being obstructed, and this makes it possible to continue cooling the engine 6 by the cooling air.

Furthermore, according to the present embodiment, the motor for driving the blower fan 7 is the engine 6. Thus, the powerful power blower 1 can be provided.

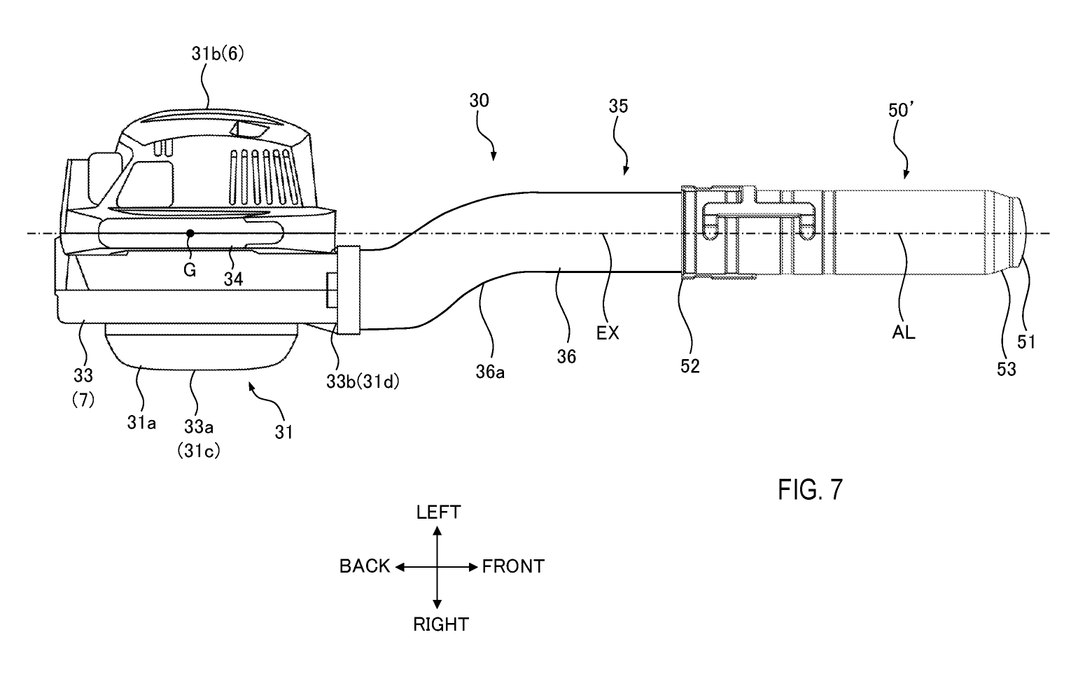

Next, a second embodiment of the present invention will be described with reference to FIGS. 7 to 10.

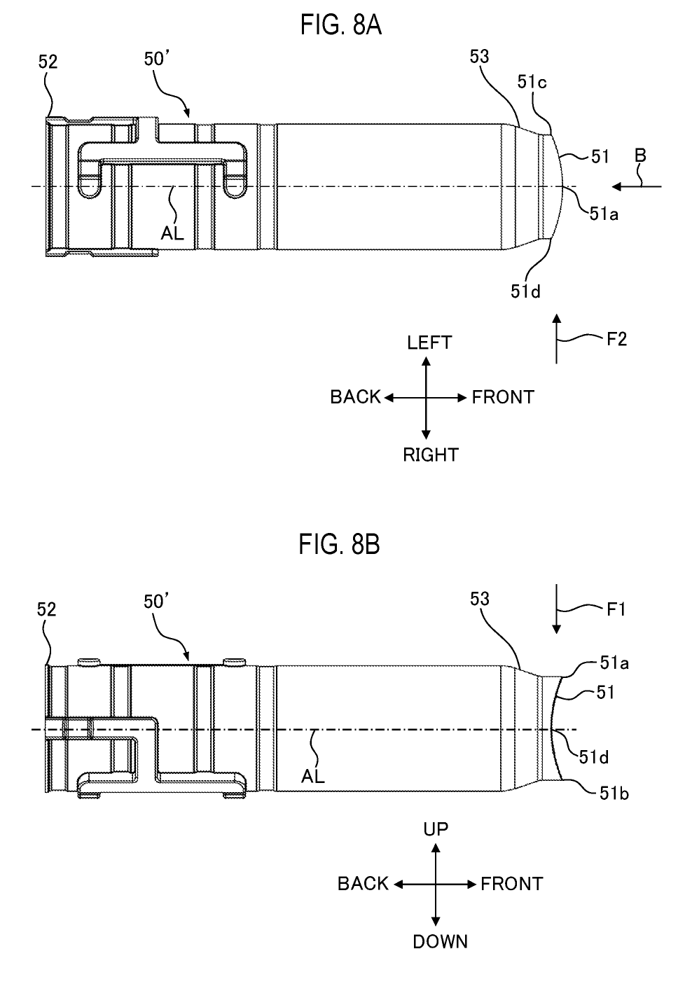

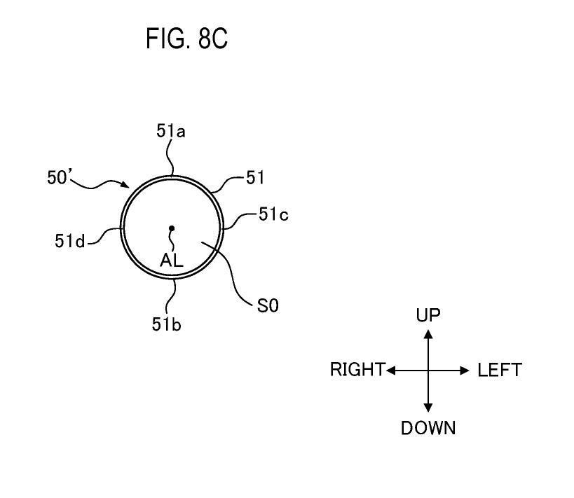

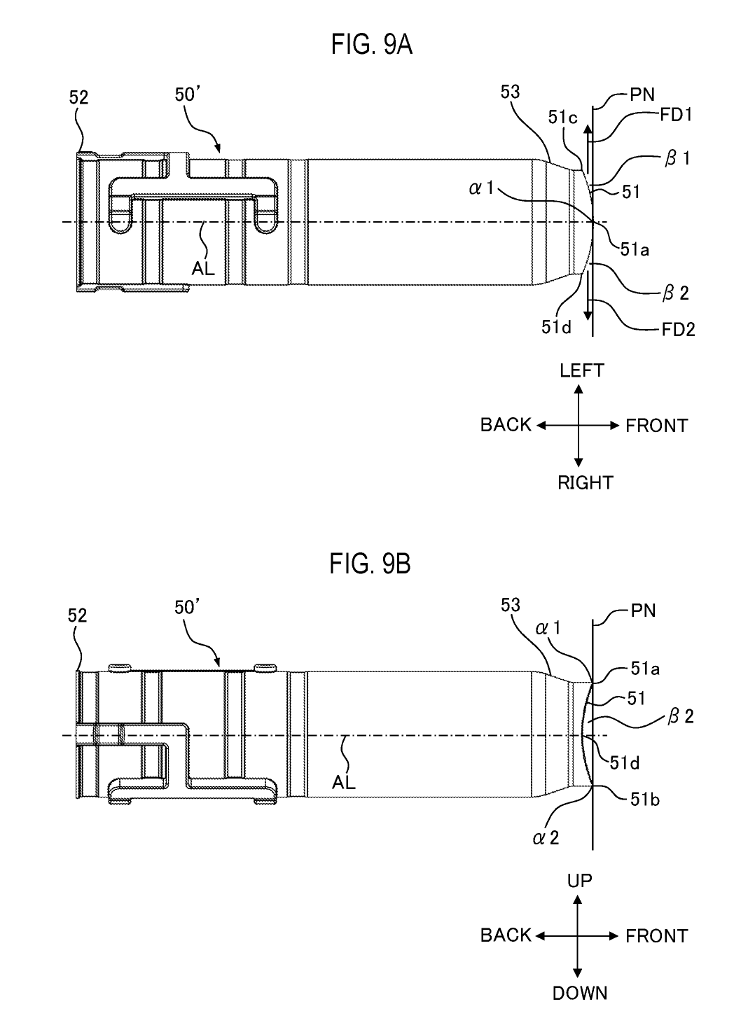

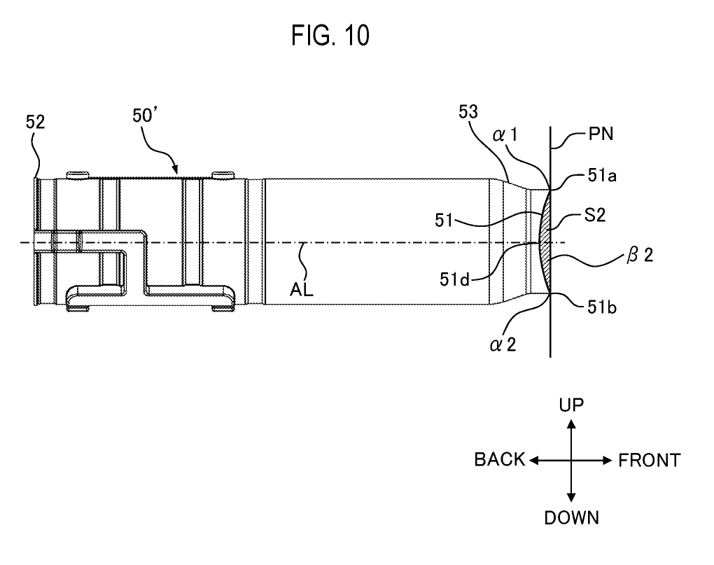

FIG. 7 illustrates a power blower 30 according to the present embodiment. FIGS. 8A to 8C illustrate a blower tube member 50′ according to the present embodiment. FIGS. 9A and 9B illustrate a state in which the plane PN that is perpendicular to an axis AL of the blower tube member 50′ is in contact with an opening 51 at the tip end side of the blower tube member 50′. FIG. 10 is a view illustrating an opening area S2 of a right blown-air passage β2 according to the present embodiment.

The power blower 30 will be described with the front and back, and the right and left thereof defined as indicated in FIG. 7 for the purpose of illustration. In addition, the blower tube member 50′ will be described with the up and down, the front and back, and the right and left thereof defined as indicated in FIGS. 8A to 8C. Although the present embodiment will also be described by employing an engine (internal combustion engine) 6 as an example of a motor, the motor is not limited to the engine 6.

The following will describe differences from the first embodiment described above.

The power blower 30 as illustrated in FIG. 7 is a hand-held engine blower. The power blower 30 has an air discharge portion 31d (discharge port 33b of a volute case 33) of a power blower main body 31 communicating with a blower tube 35 that allows air to be discharged. On a right side portion 31a of the power blower main body 31, the volute case 33 having an intake port 33a and the discharge port 33b of air, is disposed. The blower fan 7 is accommodated in the volute case 33. On a left side portion 31b of the power blower main body 31, an engine 6 that rotates the blower fan 7 is disposed. The engine 6 is integrally assembled to the volute case 33. The power blower main body 31 is configured to take in air through an air intake portion 31c (intake port 33a of the volute case 33) by rotation of the blower fan 7 driven by the engine 6 and to discharge the air from the air discharge portion 31d (discharge port 33b of the volute case 33). That is, the power blower main body 31 has the blower fan 7 rotated by the engine 6, the air intake portion 31c, and the air discharge portion 31d. In the power blower main body 31, the engine 6 and the blower fan 7 are arranged side by side in the horizontal direction (right-and-left direction).

To the power blower main body 31, a grip 34 configured to be held by an operator is attached. The grip 34 is provided with a control lever (not illustrated) for controlling operation of the power blower 30. This makes it possible for an operator to control operation of the power blower 30 by manipulating the control lever, while holding the grip 34. The grip 34 is located right above the center of gravity G of the power blower main body 31.

The blower tube 35 includes a pipe 36 joined to the air discharge portion 31d (discharge port 33b of the volute case 33) of the power blower main body 31, and a blower tube member (end nozzle) 50′ joined to the pipe 36. The pipe 36 has a bent portion 36a. In the present embodiment, when viewed from the above of the power blower 30 (i.e., viewed in plan view), the bent portion 36a of the pipe 36 is formed so that the center of gravity G of the power blower main body 31 and the grip 34 are located on an extension EX of the axis AL of the blower tube member 50′. Thus, when viewed from the above of the power blower 30 (i.e., viewed in plan view), the center of gravity G of the power blower main body 31 and the grip 34 are located on the extension EX of the axis AL of the blower tube member 50′.

The blower tube member 50′ illustrated in FIGS. 7 and 8A to 8C is a tubular member having a circular cross-section. The axis AL corresponding to the central axis of the blower tube member 50′ is linear. For example, the blower tube member 50′ may be made of resin. The blower tube member 50′ includes the opening 51 at the tip end side, an opening 52 at the base end side, and a tapered portion 53 formed between the openings 51, 52. The configurations of the opening 51 at the tip end side, the opening 52 at the base end side, and the tapered portion 53 are the same as those in the first embodiment described above. Thus, as illustrated in FIGS. 9A and 9B, when the plane PN is in contact with the opening 51 at the tip end side of the blower tube member 50′, blown-air passages β1, β2 defined by the opening 51 at the tip end side of the blower tube member 50′ and the plane PN are formed on both right and left sides of contact portions α1, α2 of the opening 51 at the tip end side of the blower tube member 50′ and the plane PN. A flow direction FD1 of air blown out from the left blown-air passage β1 and a flow direction FD2 of air blown out from the right blown-air passage β2 are opposite to each other. An opening area 51 of the left blown-air passage β1 when viewed in the flow direction FD1 of air blown out from the left blown-air passage β1, and an opening area S2 (see FIG. 10) of the right blown-air passage β2 when viewed in the flow direction FD2 of air blown out from the right blown-air passage β2 are the same. It is preferable that the sum of the opening area S1 of the left blown-air passage β1 and the opening area S2 of the right blown-air passage β2 be greater than or equal to 10% of an opening area S0 of the opening 51 at the tip end side of the blower tube member 50′ (see FIGS. 8C and 10).

In particular, according to the present embodiment, the power blower 30 is provided with the grip 34 attached to the power blower main body 31 and configured to be held by an operator. The grip 34 is located right above the center of gravity G of the power blower main body 31. When viewed in plan view, the center of gravity G of the power blower main body 31 and the grip 34 are located on the extension EX of the axis AL of the blower tube member 50′. Furthermore, in the present embodiment, even in a state in which the opening 51 at the tip end side of the blower tube member 50′ is brought into contact with the plane PN such as the ground, air which has flowed through the blower tube member 50′ can be evenly blown out rightward and leftward from the opening 51 at the tip end side of the blower tube member 50′ through the blown-air passages β1, β2 in a well-balanced state. Thus, even in a state in which the opening 51 at the tip end side of the blower tube member 50′ is brought into contact with plane PN such as the ground, since a reaction force of the pressure (discharge pressure) of air blown out from the opening 51 at the tip end side of the blower tube member 50′ acts on the power blower main body 31 and the grip 34 along the extension EX of the axis AL of the blower tube member 50′, including the center of gravity G of the power blower main body 31, it is possible to prevent occurrence of rotation moment around the center of gravity G of the power blower main body 31 caused by the reaction force. Thus, it is possible for an operator to stably hold the power blower 30.

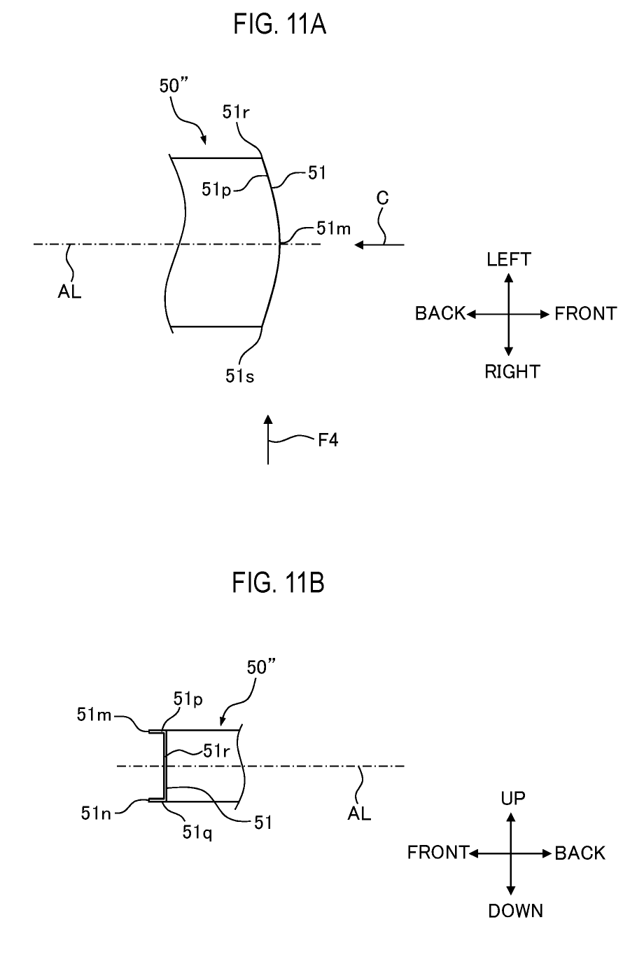

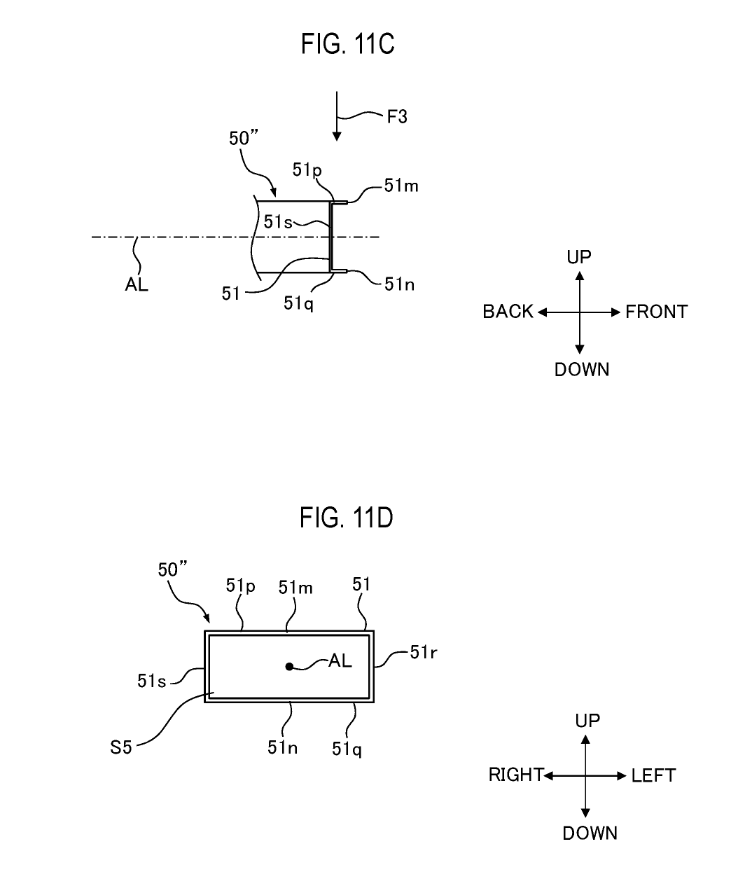

Next, a third embodiment of the present invention will be described with reference to FIGS. 11A to 13B.

FIGS. 11A to 11D illustrate a tip end portion of a blower tube member 50″ according to the present embodiment. The blower tube member 50″ will be described with the up and down, the front and back, and the right and left thereof defined as indicated in FIGS. 11A to 11D.

The following will describe differences from the first embodiment described above.

The blower tube member 50″ according to the present embodiment has the tip end portion having a horizontally elongated rectangular cross-section, as a so-called flat nozzle, instead of the cross-section according to the first embodiment described above. An axis AL corresponding to the central axis of the blower tube member 50″ is linear. For example, the blower tube member 50″ may be made of resin. The blower tube member 50″ includes an opening 51 at the tip end side, an opening 52 at the base end side, and a tapered portion 53 formed between the openings 51, 52. The configurations of the opening 51 at the tip end side, the opening 52 at the base end side, and the tapered portion 53 are the same as those in the first embodiment described above.

The opening 51 at the tip end side of the blower tube member 50″ has a rectangular shape as illustrated in FIG. 11D, and has an upper edge 51p and a lower edge 51q corresponding to the longer sides of the rectangle, and a left edge 51r and a right edge 51s corresponding to the shorter sides of the rectangle.

In the present embodiment, as illustrated in FIG. 11A, when the blower tube member 50″ is viewed in a first direction F3 that is perpendicular to the axis AL of the blower tube member 50″ (e.g., in a direction from up to down, as illustrated in FIG. 11C), the upper edge 51p of the opening 51 at the tip end side of the blower tube member 50″ has an outline that is smoothly convex in a manner such that the outline approaches a base end (opening 52) of the blower tube member 50″ farther from the axis AL of the blower tube member 50″. In other words, as illustrated in FIG. 11A, when the blower tube member 50″ is viewed in the first direction F3 that is perpendicular to the axis AL of the blower tube member 50″, the upper edge 51p of the opening 51 at the tip end side of the blower tube member 50″ has an outline that is smoothly convex to the front (convex shape). A vertex 51m of the outline of the upper edge 51p of this convex shape is illustrated in FIGS. 11A to 11D.

Similarly, the lower edge 51q of the opening 51 at the tip end side of the blower tube member 50″ has an outline that is smoothly convex in a manner such that the outline approaches the base end (opening 52) of the blower tube member 50″ farther from the axis AL of the blower tube member 50″. In other words, the lower edge 51q of the opening 51 at the tip end side of the blower tube member 50″ has an outline that is smoothly convex to the front (convex shape). A vertex 51n of the outline of the lower edge 51q of this convex shape is illustrated in FIGS. 11B to 11D.

As illustrated in FIG. 11A, when the blower tube member 50″ is viewed in the first direction F3, the opening 51 at the tip end side of the blower tube member 50″ has an outline having line symmetry with respect to the axis AL of the blower tube member 50″.

In the present embodiment, as illustrated in FIG. 11C, when viewed in a second direction F4 that is perpendicular to the axis AL of the blower tube member 50″ and is perpendicular to the first direction F3 (e.g., in a direction from right to left, as illustrated in FIG. 11A), the opening 51 at the tip end side of the blower tube member 50″ has an outline having a C-shape (concave shape) concavely curved backward.

Here, as illustrated in FIG. 11C, when the blower tube member 50″ is viewed in the second direction F4, the opening 51 at the tip end side of the blower tube member 50″ has an outline having line symmetry with respect to the axis AL of the blower tube member 50″.

Thus, the opening 51 at the tip end side of the blower tube member 50″ according to the present embodiment has the left edge 51r and the right edge 51s located behind the vertex 51m of the upper edge 51p and the vertex 51n of the lower edge 51q. In other words, the opening 51 at the tip end side of the blower tube member 50″ according to the present embodiment has the left edge 51r and the right edge 51s located at the base end side (opening 52 side) of the blower tube member 50″ with respect to the vertex 51m of the upper edge 51p and the vertex 51n of the lower edge 51q.

For example, the blower tube member 50″ having the opening 51 at the tip end side with the outline described above, may be formed by injection molding. Alternatively, blower tube member 50″ having an opening 51 at the tip end side with a flat outline may be prepared and the blower tube member 50″ may be subjected to cutting so that the outline of the opening 51 at the tip end side has the convex shape described above.

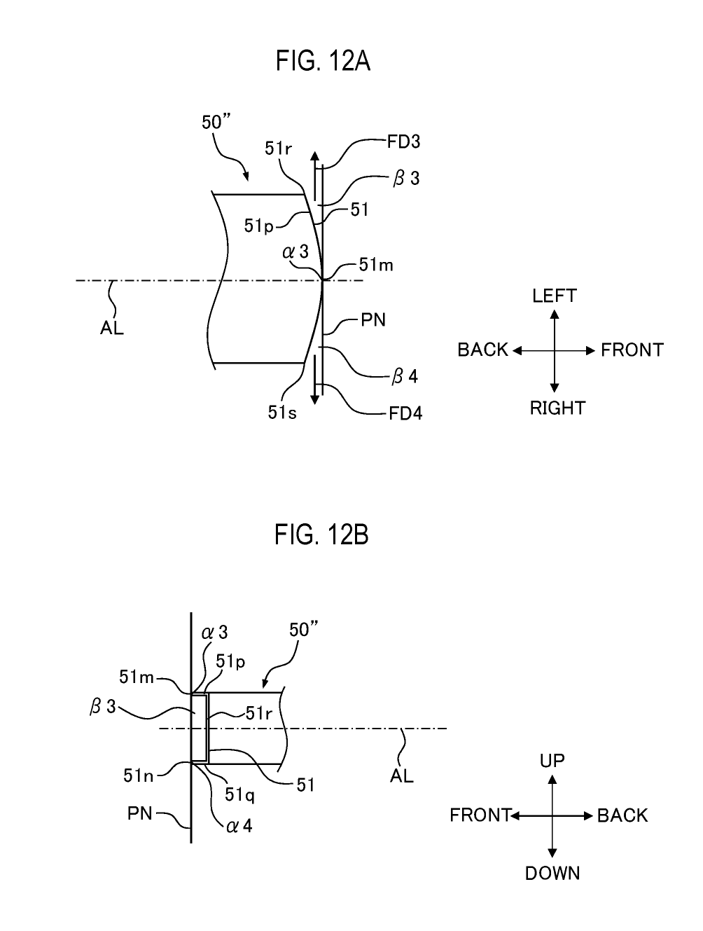

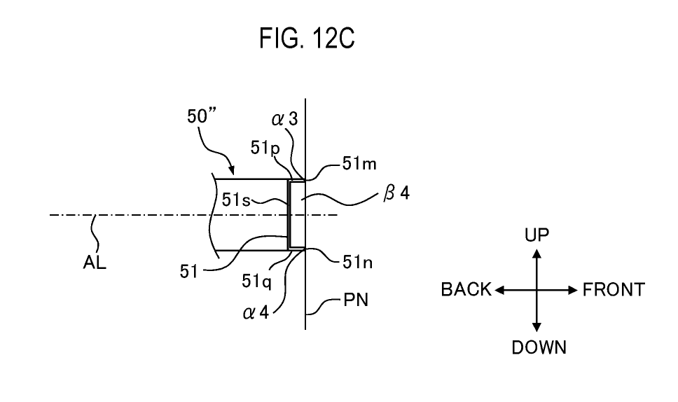

FIGS. 12A to 12C are views illustrating blown-air passages β3, β4 according to the present embodiment. FIGS. 12A to 12C illustrate a state in which the plane PN that is perpendicular to the axis AL of the blower tube member 50″ is in contact with the opening 51 at the tip end side of the blower tube member 50″.

When the plane PN is in contact with the opening 51 at the tip end side of the blower tube member 50″, the blown-air passages β3, β4 defined by the opening 51 at the tip end side of the blower tube member 50″ and the plane PN are formed on both right and left sides of contact portions α3, α4 of the opening 51 at the tip end side of the blower tube member 50″ and the plane PN. Herein, the contact portion α3 is a portion in which the vertex 51m of the upper edge 51p of the opening 51 at the tip end side of the blower tube member 50″ is in contact with the plane PN. The contact portion α4 is a portion in which the vertex 51n of the lower edge 51q of the opening 51 at the tip end side of the blower tube member 50″ is in contact with the plane PN. In a state in which the plane PN is in contact with the opening 51 at the tip end side of the blower tube member 50″, air which has flowed in the blower tube member 50″ through the opening 52 at the base end side and has flowed through the blower tube member 50″, can be blown out to the outside (outside the blower tube member 50″) through the right and left blown-air passages β3, β4.

Most air to be blown out from the left blown-air passage β3 is blown out leftward along a flow direction FD3. On the other hand, most air to be blown out from the right blown-air passage β4 is blown out rightward along a flow direction FD4. Thus, the flow direction FD3 of air blown out from the left blown-air passage β3 and the flow direction FD4 of air blown out from the right blown-air passage β4 are opposite to each other.

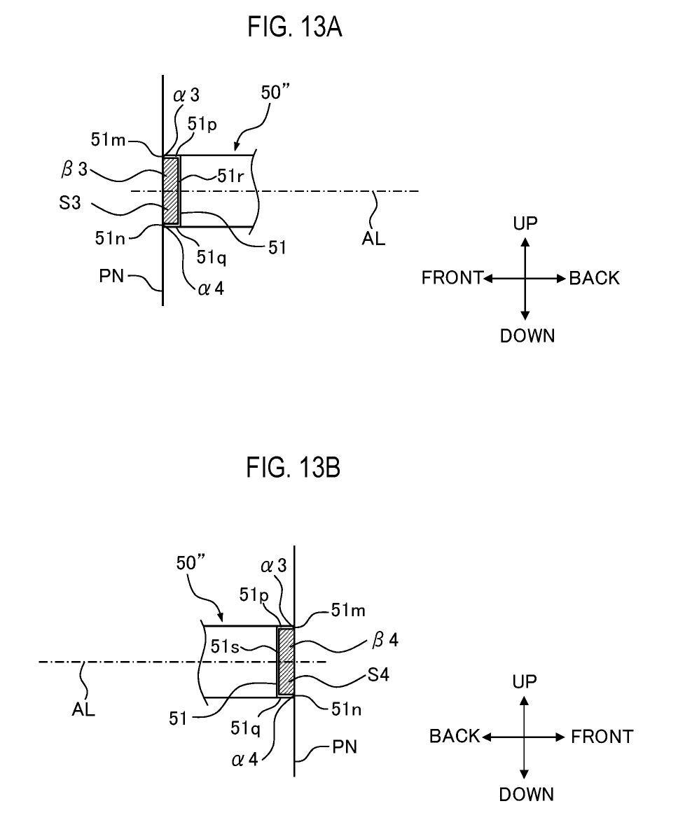

FIG. 13A is a view illustrating an opening area S3 of the left blown-air passage β3 according to the present embodiment. FIG. 13B is a view illustrating an opening area S4 of the right blown-air passage β4 according to the present embodiment.

In the present embodiment, the opening area S3 of the left blown-air passage β3 when viewed in the flow direction FD3 of air blown out from the left blown-air passage β3, and the opening area S4 of the right blown-air passage β4 when viewed in the flow direction FD4 of air blown out from the right blown-air passage β4 are the same. Thus, in the present embodiment, when the plane PN is in contact with the opening 51 at the tip end side of the blower tube member 50″, air which has flowed through the blower tube member 50″ can be equally blown out rightward and leftward from the opening 51 at the tip end side of the blower tube member 50″. Herein, the flow directions FD3, FD4 are perpendicular to a line connecting the contact portions α3, α4 and are perpendicular to the axis AL of the blower tube member 50″.

In the present embodiment, when the opening 51 at the tip end side of the blower tube member 50″ is viewed from the left of the blower tube member 50″, an area surrounded by the outline of the opening 51 at the tip end side of the blower tube member 50″ and the plane PN corresponds to the opening area S3 of the left blown-air passage β3 (see FIG. 13A). Furthermore, when the opening 51 at the tip end side of the blower tube member 50″ is viewed from the right of the blower tube member 50″, an area surrounded by the outline of the opening 51 at the tip end side of the blower tube member 50″ and the plane PN corresponds to the opening area S4 of the right blown-air passage β4 (see FIG. 13B).

Assuming that an opening area of the opening 51 at the tip end side of the blower tube member 50″ (i.e., an area surrounded by the inner periphery of the opening 51 at the tip end side of the blower tube member 50″ as illustrated in FIG. 11D) is S5, it is preferable that the sum of the opening area S3 of the left blown-air passage β3 and the opening area S4 of the right blown-air passage β4 be greater than or equal to 10% of the opening area S5. That is, it is preferable that the opening areas S3, S4, S5 satisfy the following equation (2):

(S3+S4)/S5≥0.1 (2)

In the present embodiment, the outlines of the longer sides of the rectangular opening 51 at the tip end side of the blower tube member 50″ (outlines of the upper and lower edges 51p, 51q) are formed in the convex shape and the outlines of the shorter sides thereof (outlines of the left and right edges 51r, 51s) are formed to be linear. However, the outlines of the shorter sides (outlines of the left and right edges 51r, 51s) may be formed in the convex shape and the outlines of the longer sides (outlines of the upper and lower edges 51p, 51q) may be formed to be linear.

In the first to third embodiments, the vertical direction and the right-and-left direction of the blower tube members 50, 50′, 50″ may be interchanged. That is, the opening 51 at the tip end side of each of the blower tube members 50, 50′, 50″ in the first to third embodiments may have a shape rotated by 90° around the axis AL.

In the first to third embodiments, the opening 51 at the tip end side of the blower tube members 50, 50′, 50″ has the circular or rectangular cross-section. However, the shape of the cross-section is not limited thereto, and it may be other shapes such as an ellipse or an oval shape and a rectangular shape with rounded corners.

Although the first to third embodiments are described by employing the engine as an example of a motor, the motor is not limited to the engine. For example, an electric motor may be used.

According to one aspect of the power blower, when the plane that is perpendicular to the axis of the blower tube member is in contact with the opening at the tip end side of the blower tube member, blown-air passages are formed on opposite sides of the contact portions of the plane and the opening at the tip end side of the blower tube member. Thus, even when the opening at the tip end side of the blower tube member is brought into contact with a plane such as the ground, since the blown-air passages are formed thereby, it is possible to prevent the opening at the tip end side of the blower tube member from being obstructed.

The embodiments of the present invention have been described above, the present invention is not limited thereto, and further modifications and changes can be made based on the technical concept of the present invention.

What is claimed is:

1. A power blower comprising:
a power blower main body having a blower fan rotated by a motor, an air intake portion, and an air discharge portion, the power blower main body taking in air through the air intake portion by rotation of the blower fan and discharging the air from the air discharge portion; and
a blower tube member having an opening on a base end side through which air discharged from the air discharge portion of the power blower main body flows in, and an opening on a tip end side from which the air which has flowed in, is blown out,
wherein when a plane that is perpendicular to an axis of the blower tube member is in contact with the opening at the tip end side of the blower tube member, blown-air passages defined by the opening at the tip end side of the blower tube member and the plane are formed on opposite sides of contact portions of the opening at the tip end side of the blower tube member and the plane, and air which has flowed through the blower tube member passes through the blown-air passages at the opposite sides so that the air is blown out to the outside of the blower tube member.

2. The power blower according to claim 1, wherein when viewed in a flow direction of air blown out from each of the blown-air passages at the opposite sides, an opening area of one of the blown-air passages and that of the other of the blown-air passages are the same.

3. The power blower according to claim 1, wherein when viewed in a flow direction of air blown out from each of the blown-air passages at the opposite sides, a sum of an opening area of one of the blown-air passages and that of the other of the blown-air passages is greater than or equal to 10% of an opening area of the opening at the tip end side of the blower tube member.

4. The power blower according to claim 1, wherein a flow direction of air blown out from one of the blown-air passages and that of air blown out from the other of the blown-air passages are opposite to each other.

5. The power blower according to claim 1, wherein when viewed in a direction that is perpendicular to the axis of the blower tube member, the opening at the tip end side of the blower tube member has an outline that is convex in a manner such that the outline approaches a base end of the blower tube member farther from the axis of the blower tube member.

6. The power blower according to claim 1, wherein when viewed in a direction that is perpendicular to the axis of the blower tube member, the opening at the tip end side of the blower tube member has an outline that is concave in a manner such that the outline departs from a base end of the blower tube member farther from the axis of the blower tube member.

7. The power blower according to claim 1,
wherein when viewed in a first direction that is perpendicular to the axis of the blower tube member, the opening at the tip end side of the blower tube member has an outline that is convex in a manner such that the outline approaches a base end of the blower tube member farther from the axis of the blower tube member,
wherein when viewed in a second direction that is perpendicular to the axis of the blower tube member and is perpendicular to the first direction, the opening at the tip end side of the blower tube member has an outline that is concave in a manner such that the outline departs from the base end of the blower tube member farther from the axis of the blower tube member.

8. The power blower according to claim 1, wherein the axis of the blower tube member extends linearly.

9. The power blower according to claim 8, further comprising a grip attached to the power blower main body and configured to be held by an operator,
wherein the grip is located right above the center of gravity of the power blower main body,
wherein when viewed in plan view, the center of gravity of the power blower main body and the grip are located on an extension of the axis of the blower tube member.

10. The power blower according to claim 1, wherein the power blower main body further has a guide that guides, toward the motor, a part of air taken in through the air intake portion by rotation of the blower fan.

11. The power blower according to claim 1, wherein the motor is an engine.
